(19) United States
(12) Patent Application Publication
(10) Pub. No.: US 2025/0066124 A1
(43) Pub. Date: Feb. 27, 2025

(54) WAREHOUSE DATABASE MANAGEMENT SYSTEM FOR MANAGING A WAREHOUSE WITH A HUMAN-AUTONOMOUS MOBILE ROBOT ORDER PICKING SYSTEM AND ASSOCIATED METHOD OF USE

(71) Applicant: THE CURATORS OF THE UNIVERSITY OF MISSOURI, Columbia, MO (US)

(72) Inventors: Sharan Srinivas, Columbia, MO (US); Shitao Yu, Columbia, MO (US)

(21) Appl. No.: 18/812,697

(22) Filed: Aug. 22, 2024

Related U.S. Application Data
(60) Provisional application No. 63/578,087, filed on Aug. 22, 2023.

(51) Int. Cl. B65G 1/137; B65G 61/00; G06Q 10/087

(52) U.S. Cl. CPC B65G 1/1378; B65G 61/00; G06Q 10/087

(57) ABSTRACT

A computerized warehouse management system and method of use are disclosed that generates a plan for optimizing the order-picking operations for a collaborative human-robot order-picking system. Specifically, the computerized warehouse management system is flexible and scalable to handle any facility layout, swarm of robots, multiple pickers, and logistical/operational constraints. The platform optimizes four key decisions to improve warehouse operations efficiency, including order batching, batch assignment to robots and pickers, batch sequencing, and collaborative human-robot routing.

### CROSS REFERENCE TO RELATED APPLICATIONS

This application claims priority under 35 U.S.C. § 119 to provisional patent application U.S. Ser. No. 63/578,087, filed Aug. 22, 2023. The provisional patent application is herein incorporated by reference in its entirety, including, without limitation, the specification, claims, and abstract, as well as any figures, tables, appendices, or drawings thereof.

### TECHNICAL FIELD

The present disclosure generally relates to a computerized warehouse management system and method of use that generates a plan for optimizing the order-picking operations for a collaborative human-robot order-picking system.

### BACKGROUND

The background description provided herein gives context for the present disclosure. The work of the presently named inventors, as well as aspects of the description that may not otherwise qualify as prior art at the time of filing, are neither expressly nor impliedly admitted as prior art.

Order picking, which involves retrieving items from storage locations for an internal or external customer, is a core function in warehouses and accounts for up to 65% of the total operating cost. Moreover, order picking is considered a crucial driver for supply chain performance as improper planning of picking operations leads to inefficient asset utilization and delayed deliveries, which, in turn, adversely affect customer satisfaction, operating cost, and competitiveness. A majority of the warehouses adopt the traditional picker-to-parts order picking system (OPS), where pickers travel through the warehouse to retrieve and transport the items from their storage location to the packing station. For instance, 80% of warehouses in Western Europe employ picker-to-parts (“OPS”). Such warehouses typically use low-level picking by storing the stock-keeping units (“SKUs”) or items in storage racks. With the recent rapid growth in the e-commerce sector and changing consumer delivery expectations, warehouses are now faced with the challenge of handling high demand and tight due dates.

While the picker-to-parts system requires a relatively low investment cost, it is labor-intensive and contributes to about 60% of all labor activities in the supply chain. Automation, enabled by Industry 4.0 technologies, provides the capability to reduce the dependence on labor resources and improve overall warehouse operations. In particular, autonomous mobile robots (“AMR”) can alleviate the strain on human pickers as they provide the following advantages: flexibility and safety, faster and more efficient transport, and easy integration and scalability.

However, while the above-mentioned capabilities make AMRs ideal for transport, their gripping/grasping ability is inferior to human grasping. This is mainly because the current technology, such as 3D image identification, sensor and pressure feedback mechanism, and object recognition availability, limit the robotic grasping of an object in a dynamic environment. While specialized picker robots may be used to complement the AMRs, such a fully automated OPS system becomes a capital-intensive operation instead of a traditional setup. Thus, a collaborative human-robot order picking system (CHR-OPS), where humans perform item retrieval tasks (picking from storage and placing them on robots) and AMRs transport these items to the drop-off location, has the potential to leverage the strengths of both the resources (humans and AMRs) to achieve faster fulfillment.

The CHR-OPS can be broadly categorized into follow-pick (picker-in lead or robot-in lead) and swarm systems. The former category employs AMR, which accompanies human workers performing the pick-and-place operation and returns independently to the packing station once all the items in a batch have been collected, reducing the walking distance and cart operation effort for humans. The routes adopted by each human-robot pair are very similar in the follow-pick system because the AMR either follows the picker (picker-in lead) or leads the human worker (robot-in lead). Such a system is well-suited for transitioning from a single order picking method (fulfill one order at a time) to a batch order picking system (bulk retrieval of SKUs to deliver multiple orders per tour). Nevertheless, the follow-pick system may not achieve the best tradeoff between fulfillment speed and resources employed (pickers and humans) for a warehouse characterized by a low-density, high-volume pick environment.

On the other hand, the swarm system is applicable to different warehouse environments. It uses AMRs that navigate independently and allow any nearby human picker to meet with a robot to perform the pick-and-place task. However, unlike the follow-pick system, the routes of the multiple AMRs and human pickers need not be similar and must be efficiently planned or optimized. FIG. 1 shows the two types of robots used in the follow-pick 10 and swarm CHR-OPS 12.

Thus, there is a need in the art for a computerized system that combines AMRs and human pickers and maximizes efficiency in delivering items from a warehouse to a depot.

### SUMMARY

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is still yet a further object, feature, and/or advantage of the present disclosure to have a computerized warehouse management system for managing a warehouse with a human-autonomous mobile robot order picking system, the computerized warehouse management system that includes at least one processor and memory in communication with the at least one processor, wherein the computerized warehouse management system is programmed to perform operations including determining how many items should be collected in each tour of the at least one autonomous mobile robot, assigning batches to the at least one autonomous mobile robot, and develop coordinated routing of the at least one autonomous mobile robot and the associated human picker that is then followed by: (a) directing at least one autonomous mobile robot of a plurality of autonomous mobile robots to a location of a first item in a batch of items from an initial location, (b) determining if a human picker has arrived at that location; (c) receiving an item from the human picker by the at least one autonomous mobile robot, (d) directing the at least one autonomous mobile robot to move to the location of the next item in the batch and repeat steps (b)-(c), (e) determining if all programmed tours of the at least one autonomous mobile robot have been completed and if not, then repeat steps (a)-(d), and (f) directing at least one autonomous mobile robot of a plurality of autonomous mobile robots to return to the initial location upon completion of step (e).

An aspect of the present disclosure is that a number of items for pickup by the at least one autonomous mobile robot is optimized for a tour for each batch with the at least one processor.

Another aspect of the present disclosure is that each batch assignment for each autonomous mobile robot is optimized with the at least one processor.

It is a further object, feature, and/or advantage of the present disclosure is that the routing of the at least one autonomous mobile robot and the associated human picker to minimize picking time with the at least one processor.

Yet another aspect of the present disclosure is a speed of the at least one autonomous mobile robot is determined by the processor to optimize efficiency with the at least one processor.

Another feature of the present disclosure is an item holding capacity of the at least one autonomous mobile robot is determined by the processor to optimize efficiency with the at least one processor.

Yet another aspect of the present disclosure is a combination of the at least one autonomous mobile robot, and the associated human picker evaluated the processor to optimize efficiency with the at least one processor.

Still, yet another feature of the present disclosure is multiple items from a same order can be split among autonomous mobile robot and associated human picker teams with the at least one processor.

Another feature of the present disclosure is that order batching, assignment,

sequencing, and routing are performed utilizing the at least one processor utilizing restarted simulated annealing with an adaptive neighborhood search mechanism.

Still another aspect of the present disclosure is a method for managing a computerized warehouse with a human-autonomous mobile robot order picking system, the computerized warehouse management system includes determining operations including how many items should be collected in each tour of at least one autonomous mobile robot, assigning batches to at least one autonomous mobile robot, and develop coordinated routing of the at least one autonomous mobile robot and an associated human picker with at least one processor and memory in communication with the at least one processor having a computerized warehouse management system, (a) directing at least one autonomous mobile robot of a plurality of autonomous mobile robots to a location of a first item in a batch of items from an initial location with the at least one processor, (b) determining if a human picker has arrived at that location with the at least one processor, (c) receiving an item from the human picker by the at least one autonomous mobile robot with the at least one processor, (d) directing the at least one autonomous mobile robot to move to the location of the next item in the batch and repeat steps (b)-(c) with the at least one processor, (e) determining if all programmed tours of the at least one autonomous mobile robot have been completed and if not, then repeat steps (a)-(d) with the at least one processor, and (f) directing at least one autonomous mobile robot of a plurality of autonomous mobile robots to return to the initial location upon completion of step (e) with the at least one processor.

A further feature of the disclosure includes optimizing a number of items for pickup by the at least one autonomous mobile robot for a tour for each batch with the at least one processor.

Still, another feature of the present disclosure includes optimizing each batch assignment for each autonomous mobile robot with the at least one processor.

Still yet another feature of the present disclosure includes the routing of the at least one autonomous mobile robot and the associated human picker to minimize picking time with the at least one processor.

Another aspect of the present disclosure includes determining a speed of the at least one autonomous mobile robot by the processor to optimize efficiency with the at least one processor.

An additional feature of the disclosure includes determining an item holding capacity of the at least one autonomous mobile robot by the processor to optimize efficiency with the at least one processor.

Yet another feature of the method of the present disclosure includes evaluating wherein a combination of the at least one autonomous mobile robot and associated human picker is evaluated the processor to optimize efficiency with the at least one processor.

It is still yet another feature of the method of the present disclosure, which includes evaluating a combination of the at least one autonomous mobile robot and associated human picker with a warehouse layout with the processor to optimize efficiency with the at least one processor.

It still another feature of the method of the present disclosure includes splitting

multiple items from the same order among autonomous mobile robot and associated human picker teams with the at least one processor.

It is yet another feature of the method of the present disclosure that includes performing order batching, assignment, sequencing, and routing with the at least one processor utilizing restarted simulated annealing with an adaptive neighborhood search mechanism.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a prior art Illustrative representation of autonomous mobile robots employed in the (a) follow-pick and (b) swarm system.

FIG. 2 shows an illustration of the block warehouse layout.

FIG. 3 is a flowchart of a pick-and-place process from a human picker's perspective in a CHR-OPS.

FIG. 4 is a flowchart of an item collection process from AMR's perspective in a CHR-OPS.

FIG. 5 (a) is a general illustration of a solution of CHR-OBASRP.

FIG. 5 (b) is a numeral illustration of mission and pick lists.

FIG. 6 (a) is an illustration of neighborhood structures that uses the move operator (N1-N4).

FIG. 6 (b) is an illustration of neighborhood structures that use the swap operator (N5-N8).

FIG. 7 is a graphical analysis of the impact of varying AMR cart capacity on average total tardiness for instances with | [symbol] |=50.

FIG. 8 is a graphical analysis of the impact of varying AMR cart capacity on average total tardiness for instances with 50 items.

FIG. 9 is a graphical analysis of the impact of varying AMR cart capacity on average total tardiness for instances with 100 items.

FIG. 10 is a graphical analysis of the impact of decreasing AMR travel speed from 2 ft/s to 1 ft/s.

FIG. 11 is a graphical analysis of the impact of increasing AMR travel speed from 2 ft/s to 1 ft/s.

FIG. 12 shows an illustration of a two-block warehouse layout.

FIG. 13 shows an illustration of a three-block warehouse layout.

FIG. 14 is a graphical analysis of different warehouse layouts on total tardiness for instances with 50 items.

FIG. 15 is a graphical analysis of different warehouse layouts on total tardiness for instances with 100 items.

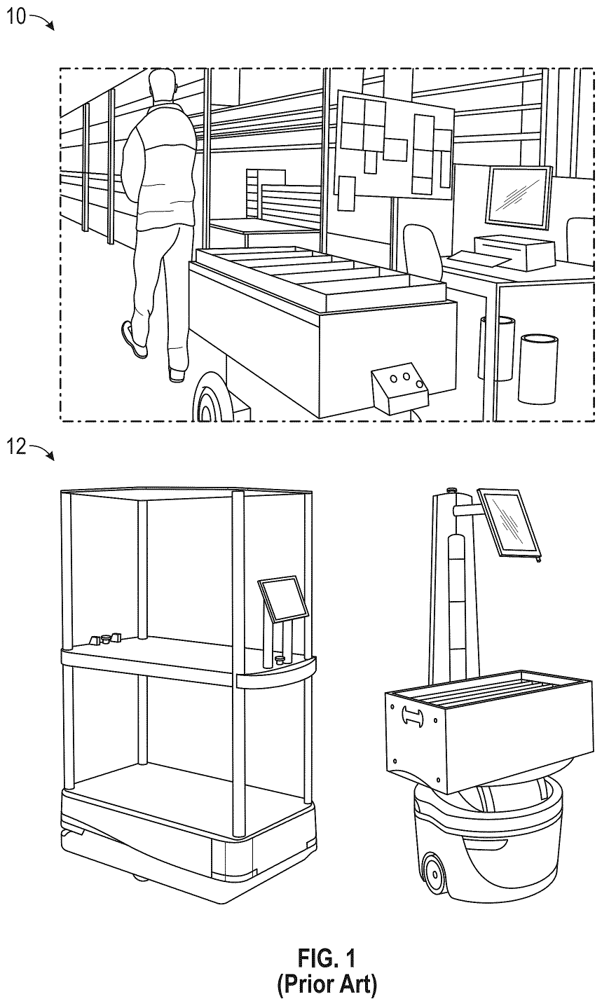

An artisan of ordinary skill in the art need not view, within the isolated figure(s), the near-infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit the basic operation of the present disclosure unless otherwise indicated.

In this disclosure, a set of orders j∈J, containing i∈ [symbol] (where | [symbol] |≥|J|) numbered items, to be picked from warehouse storage and delivered at a drop-off point (depot). Specifically, each order j∈J contains a nonempty set of items i∈j, which may correspond to one or more SKUs of varying quantities.

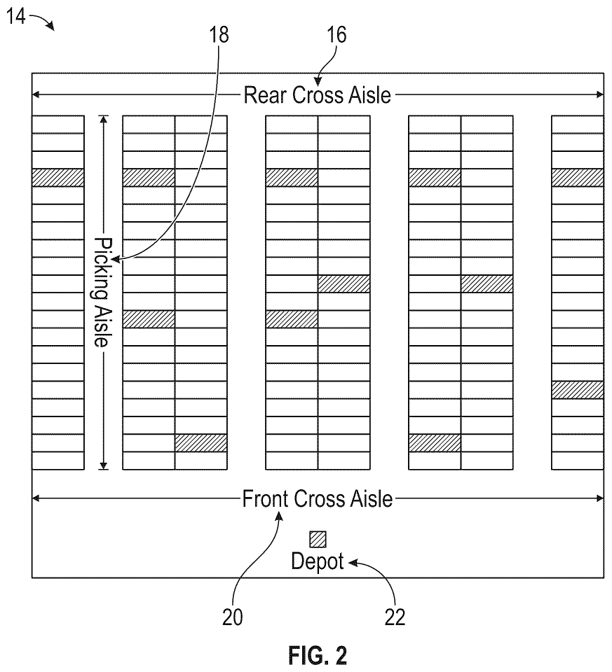

The items are stored in a block warehouse with open-end picking aisles, as shown in FIG. 2 and are generally indicated by numeral 14. The block layout constitutes picking aisles 18, a rear cross aisle 16, and a front cross aisle 20. The aisles that contain storage racks on both sides and are parallel to each other are referred to as picking aisle 18. On the other hand, the pathway that does not contain any storage bins but allows the pickers and transporters to enter/exit the picking aisle is called cross-aisle 20 and 16. Each rectangular slot represents a storage location and can store multiple items of the same SKU. Moreover, these items are stored in low-level bins, thereby allowing direct access to the picker.

Table 1 illustrates the information associated with the orders along with the item numbering scheme adopted in this disclosure.

TABLE 1
An illustrative example of orders and associated item
numbering is adopted in the optimization model.

| Order | | Item numbering | Number of bins | |
|---|---|---|---|---|
| j ∈ J | SKU | (i ∈ [symbol] ) | required (βᵢ) | Item location |
| 1 | 100001 | 1 | 2 | A01-R01-SO2- |
| | | | | PO5 |
| 1 | 230653 | 2 | 1 | A04-R02-S01- |
| | | | | P08 |
| 1 | 242411 | 3 | 2 | A04-R04-S01- |
| | | | | P03 |
| 2 | 629360 | 4 | 1 | A14-R02-S03- |
| | | | | P10 |
| 2 | 100001 | 5 | 1 | A01-R01-S02- |
| | | | | P05 |
| . . . | . . . | . . . | . . . | . . . |
| J | 365312 | N-1 | 1 | A06-R05-S02- |
| | | | | P08 |
| J | 242411 | N | 2 | A04-R04-S01- |
| | | | | P03 |

More specifically, the items in |J| orders are numbered consecutively (i.e., 1, 2, . . . , | [symbol] |), while SKU denotes a specific item. Each SKU is stored in a unique location in the warehouse and is specified by the aisle, rack, shelf, and position numbers. For instance, A01-R02-S03-P05 denotes the first aisle, second rack, third shelf, and fifth position on that level from the left. Thus, if two orders include the same item, then the item SKU and location will be the same, but the item numbering will be unique for modeling purposes (e.g., SKU 100001 is present in orders 1 and 2 in Table 1 above). Depending on the order quantity of items numbered i∈N, the number of storage bins (βi) required by the autonomous mobile robots (AMR) will be determined. However, two different item numbers i, i′∈N cannot be placed in the same bin.

The order-picking process involves a fleet of robot transporters (r∈ [symbol] ) and human pickers (k∈ [symbol] ) working in a collaborative manner. Autonomous mobile robots (AMRs) are responsible for transporting the items to the drop-off point and carrying a cart that can hold up to κᵣ items. An AMR may make t∈T tours and transport a subset of | [symbol] | items, i.e., batch, in each tour. The human workers must perform the pick-and-place operation and take ηᵢ^{U} time units to retrieve order i∈ [symbol] from the rack, and ηᵢ^{L} time units to load/place that order on the robot cart. The time taken by the AMR and human worker to travel from the pick location of item i′ to i is given by τ_{i′i}^{R} and [symbol] , respectively. Likewise, the tuples [( [symbol] ), ( [symbol] )] and [( [symbol] ), ( [symbol] )] denote the travel time between the location i and the depot for the robot and human workers, respectively. The travel times are assumed to be affected by the resource's (AMRs and human pickers) travel speed and warehouse layout.

The worker pick list and AMR mission list drive the picking operation. The pick list specifies the set of items, their location, and the sequence in which the human workers must visit them to perform the pick-and-place operation. Likewise, the mission list provides the AMRs with the number of tours and a list of items to be collected in each tour, along with their location and sequence. The pick and mission lists typically include items corresponding to different orders, but the same picker or AMR need not be responsible for collecting all the items belonging to an order. A batch is the set of items to be collected by the AMR in a tour, and directly impacts the completion time of order j(Cⱼ). The batch start time is the time at which the AMR begins tour t∈T from the depot to collect the items in that batch, while the batch completion time refers to the time at which the AMR returns to the depot to drop-off all the items in that batch. An order is complete only if all the batches containing the items pertaining to that order are returned to the depot.

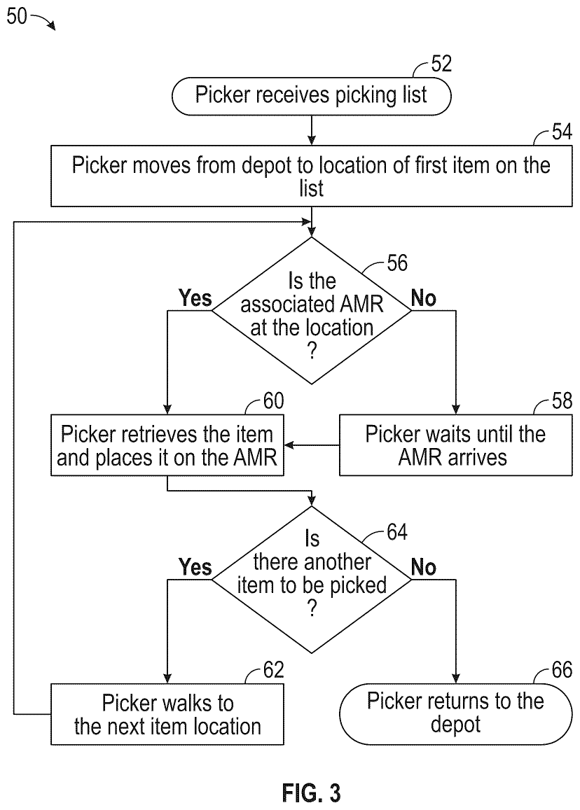

Referring now to FIG. 3, steps in flowcharts throughout this application are indicated by <nnn>. A collaborative human-robot order picking system (CHR-OPS) from a human picker's perspective is shown and indicated by the numeral 50, The first step is for a picker to receive a picking list <52>, then the picker moves from the depot to the location of the first item on the list <54>. A query is then made if the associated AMR is at the location <56>. If the response is negative, the picker waits until the AMR arrives <58>, and if positive, the picker retrieves the item and places it on the AMR <60>.

Another query is mad as to whether there is another item to be picked <64>, where if the query response is negative, the picker returns to the depot <66>, and if positive, the picker walks to the next location <62> and returns to step <56> to see is the AMR is present at the location.

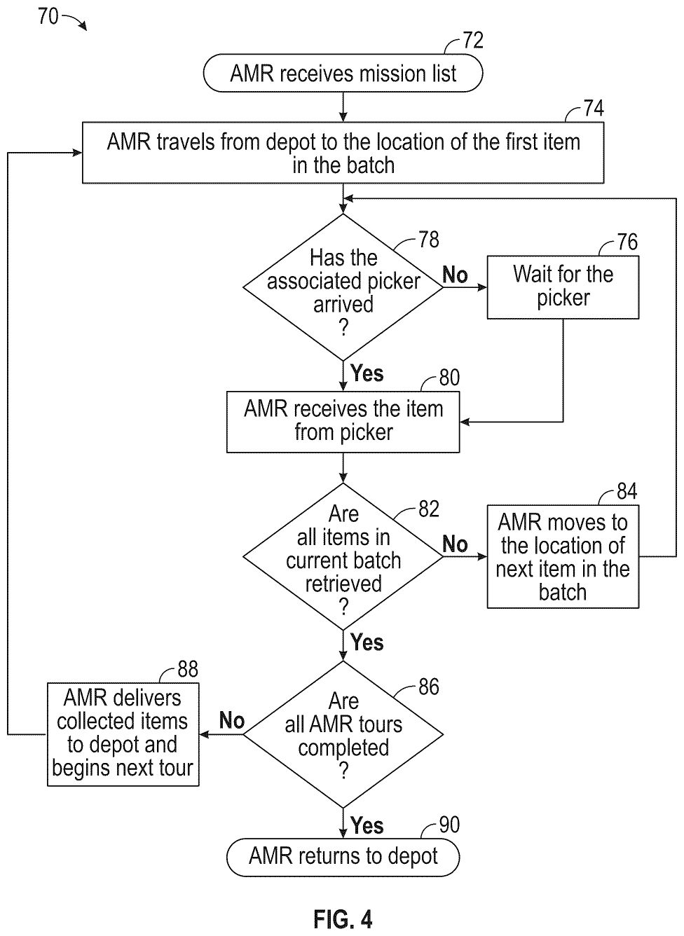

Referring now to FIG. 4, a collaborative human-robot order picking system (CHR-OPS) from an AMR's perspective is shown and generally indicated by the numeral 70. The first step is for the AMR to receive a mission list <72>, and then the AMR travels from the depot to the location of the first item in the batch <74>. A query is then posed of whether the picker has arrived <78>. If the response is negative, then the AMR will wait for the picker <76>, and if positive, the AMR receives the item from the picker <80>, which is also the same step after step <76>. A query is then made if all items in the current batch are retrieved <82>; where it is negative, the AMR moves to the location of the next item in the batch <84> and returns to step <78>. If the response to the query is positive, then a query is made to determine if all AMR tours have been completed <86>. If the response is positive, the AMR returns to the depot <90>, and if negative, the AMR delivers the collected times to the depot and begins the next tour <88> by returning to step <78>.

Typical of distribution warehouses, each order j∈J has a due date dj to ensure that the truck carrying this order can leave the facility as planned and deliver it to the external customer within the expected time window. The extent to which a due date is met depends on how well the key subproblems are solved. In other words, the items in a batch, the assignment of batches to AMR, the order in which the batches are processed, and the routing of AMRs, as well as pickers, affect the completion time of the order. A delayed fulfillment of order results in penalties (in the form of customer dissatisfaction or lost revenue) and is typically dependent on the delay duration (tardiness). Specifically, the tardiness associated with an order is the non-negative difference between order completion time and due date (i.e., Tⱼ=max {Cⱼ^{J}−dj, 0}). The total tardiness, which is the sum of tardiness associated with all orders, is an important metric pertaining to fulfillment efficiency in the literature on order picking as well as other problem areas involving customer deadlines. Given the aforementioned characteristics, the CHR-OBASRP seeks to minimize total tardiness by optimizing the following three subproblems associated with collaborative order picking.
(i) How to partition the | [symbol] | items to a set of batches? How many items should be included in a batch?
(ii) How should the batches be assigned to the set of AMRs, and in which sequence (or tour) should an AMR process the assigned batches?
(iii) Given a set of items to be collected in a batch, in what order should the AMR visit their locations? Likewise, how should the human worker be routed to coordinate the picking process?

To model the CHR-OBASRP, we have made the following assumptions. First, we consider all the pickers to walk at the same speed and all the robots to move at a constant speed. Second, the AMRs and pickers can travel in both directions in an aisle, and they always take the shortest path when traveling from one location to another. Third, picking and cross aisles are assumed to be wide enough for robots and humans to overtake or pass through from opposite directions. Therefore, the possibility of a robot or picker waiting behind another resource (blocking) is not considered. Finally, the robot and picker start. (and end) the pick operation at the depot. Note that the picker does not need to return to the depot at the end of each robot tour, but it is assumed that the picker will return once all the items have been collected.

### Indices and Sets

j∈J Set of orders.
i∈ [symbol] Set of consecutive numbering of items in J orders.
i∈ϑⱼ Set of items corresponding to order J.
r∈ [symbol] Set of autonomous mobile robots (AMRs), [symbol] ={r₁, r₂, . . . , rₘₐₓ}
k∈ [symbol] Set of human pickers, [symbol] ={k₁, k₂, . . . , kₘₐₓ}
t∈T Set of maximum allowable AMR tours (or trips)

### Parameters

M Large positive number τ_{i′,i}^{K} Travel time from the location of item i′ to the location of item i by human pickers.
[symbol] Travel time from the location of item i′ to the location of item i by AMR
κᵣ Capacity of robot r in any tour, expressed as the number of bins that can be carried by the AMR.
βᵢ Number of bins required to carry item number i from storage to drop-off point.
ηᵢ^{U} Time to retrieve (unload) item i from a storage location.
ηᵢ^{L} Time to place (load) item i on AMR's cart.
dj Due date for order j

### Decision Variables

A_{i,k}^{K} 1 if operator k is assigned to pick-and-place item, i; 0 otherwise.
[symbol] 1 if item i is batched to be transported by robot r in tour t; 0 otherwise
[symbol] 1 if robot r makes a nonempty tour t.
U_{i′,i}^{K} 1 if operator k retrieves item i before item i, but not necessarily exactly before item i (i.e., relative precedence or indirect sequencing); 0 otherwise.
[symbol] 1 if robot r collects item i′ before item in in the same trip but not necessarily exactly before item i (i.e., relative precedence or indirect sequencing); 0 otherwise.
[symbol] Retrieval begins at the time of item i by picker k
[symbol] Retrieval finish time of item i by picker k [symbol] Time at which picker k is ready to leave the location of item i [symbol] Collection finish time of item i by AMR r in tour t. [symbol] Collection begins at the time of item i by AMR r in the tour t. Cₖ^{K} Return-to-base time of worker k after completing the assigned pick-and-place tasks. [symbol] Completion time of tour t by robot r. Sₖ^{K} Start time of operator k from the depot (base) to perform pick-and-place task [symbol] Start time of tour to by robot r Cⱼ Delivery completion time of all items pertaining to order j. Tⱼ Tardiness for order j

### CHR-OBASRP Model Formulation

The model is mathematically formulated as follows.

The model is

$$min Z = {\sum }_{j ∈ J} Tj \qquad Equation 1$$

$$subject to$$

$$A \begin{matrix}K \\ i , k\end{matrix} = 1 ∀ i ∈ \qquad Equation 2$$

$${\sum }_{t ∈ T} A \begin{matrix}R \\ i , r , t\end{matrix} = 1 ∀ i ∈ \qquad Equation 3$$

$$\leq \begin{matrix}\sum \\ i\end{matrix} r ∈ ∀ i ∈ \qquad Equation 4$$

$$\begin{matrix}\sum \\ i\end{matrix} {β}_{I} \cdot A \begin{matrix} \\ i , r , t\end{matrix} \leq {𝓀}_{r} \cdot X \begin{matrix} \\ r , t\end{matrix} r ∈ , ∀ i ∈ T \qquad Equation 5$$

$$X \begin{matrix} \\ r , t\end{matrix} \geq X \begin{matrix} \\ r , t + 1\end{matrix} r ∈ , t ∈ T , t < \vert T \vert \qquad Equation 6$$

$$A \begin{matrix}K \\ i , k\end{matrix} - A \begin{matrix}K \\ {i}^{′} , k\end{matrix} \leq 1 - ( U \begin{matrix}K \\ i , {i}^{′}\end{matrix} + U \begin{matrix}K \\ {i}^{′} , i\end{matrix} ) i , i ’ ∈ , i \neq i ’ , k ∈ ? \qquad Equation 7$$

$$A \begin{matrix}K \\ i , k\end{matrix} + A \begin{matrix}K \\ {i}^{′} , k\end{matrix} \leq 1 + ( U \begin{matrix}K \\ I , {i}^{′}\end{matrix} + U \begin{matrix}K \\ {i}^{′} , i\end{matrix} ) i , i ’ ∈ , i \leq i ’ , k ∈ ? \qquad Equation 8$$

$$- \leq 1 - ( + ) i , i ’ ∈ ℕ , i \neq i ’ , r ∈ , t ∈ T \qquad Equation 9$$

$$- \leq 1 + ( + ) i , i ’ ∈ ℕ , i \leq i ’ , r ∈ , t ∈ T \qquad Equation 10$$

$$B \begin{matrix}K \\ i , k\end{matrix} \geq S \begin{matrix}K \\ k\end{matrix} + τ \begin{matrix}K \\ o , i\end{matrix} - M \cdot ( 1 - A \begin{matrix}K \\ i , k\end{matrix} ) i ∈ , k ∈ ? \qquad Equation 11$$

$$\begin{matrix}+ τ \begin{matrix}K \\ {i}^{′} , i\end{matrix} \cdot U \begin{matrix}K \\ {i}^{′} , I\end{matrix} - M \cdot ( 1 - U \begin{matrix}K \\ {i}^{′} , i\end{matrix} ) \\ i , i ’ ∈ ℕ , k ∈ ? \text{,i≠i’}\end{matrix} \qquad Equation 12$$

$$= + η \begin{matrix}U \\ i , k\end{matrix} \cdot A \begin{matrix}K \\ i , k\end{matrix} i ∈ , k ∈ ? \qquad Equation 13$$

$$\geq i ∈ , k ∈ ? \qquad Equation 14$$

$$\geq \begin{matrix}\sum \\ i ∈ T\end{matrix} - M \cdot ( 2 - A \begin{matrix}K \\ i , k\end{matrix} - \begin{matrix}\sum \\ t ∈ T\end{matrix} A \begin{matrix} \\ i , r , t\end{matrix} ) i ∈ ℕ , k ∈ ? , r ∈ \qquad Equation 15$$

$${B}_{i , k}^{K} \leq M \cdot A \begin{matrix}K \\ i , k\end{matrix} i ∈ , k ∈ ? \qquad Equation 16$$

$$F \begin{matrix}K \\ i , k\end{matrix} \leq M \cdot A \begin{matrix}K \\ i , k\end{matrix} i ∈ , k ∈ ? \qquad Equation 17$$

$$L \begin{matrix}K \\ i , k\end{matrix} \leq M \cdot A \begin{matrix}K \\ i , k\end{matrix} i ∈ , k ∈ ? \qquad Equation 18$$

$$\geq + - M \cdot ( 1 - A \begin{matrix} \\ i , r , t\end{matrix} ) i ∈ ℕ , r ∈ , t ∈ T \qquad Equation 19$$

$$\begin{matrix}\geq + \cdot - M \cdot ( 1 - ) \\ i , i ’ ∈ ℕ , r ∈ , i \neq i ’\end{matrix} \qquad Equation 20$$

$$\begin{matrix}\begin{matrix}\sum \\ t ∈ T\end{matrix} B \begin{matrix} \\ i , r , t\end{matrix} \geq - M \cdot ( - \begin{matrix}\sum \\ t ∈ T\end{matrix} - A \begin{matrix} \\ i , r , t\end{matrix} ) \\ i ∈ , k ∈ ? , r ∈\end{matrix} \qquad Equation 21$$

$$F \begin{matrix} \\ i , r , t\end{matrix} = B \begin{matrix} \\ i , r , t\end{matrix} + η \begin{matrix}L \\ i , r\end{matrix} \cdot A \begin{matrix} \\ i , r , t\end{matrix} ∀ i ∈ , r ∈ , t ∈ T \qquad Equation 22$$

$$B \begin{matrix} \\ i , r , t\end{matrix} \leq M \cdot A \begin{matrix} \\ i , r , t\end{matrix} i ∈ ℕ , r ∈ , t ∈ T \qquad Equation 23$$

$$F \begin{matrix} \\ i , r , t\end{matrix} \leq M \cdot A \begin{matrix} \\ i , r , t\end{matrix} i ∈ ℕ , r ∈ , t ∈ T \qquad Equation 24$$

$$\geq F \begin{matrix} \\ i , r , t\end{matrix} + - M \cdot ( 1 - A \begin{matrix} \\ i , r , t\end{matrix} ) i ∈ ℕ , r ∈ , t ∈ T \qquad Equation 25$$

$$\geq - M \cdot ( 1 - ) i ∈ ℕ , r ∈ \qquad Equation 26$$

$${C}_{j} \geq C \begin{matrix} \\ r , t\end{matrix} - M \cdot ( 1 - A \begin{matrix} \\ i , r , t\end{matrix} ) ∀ i ∈ ϑ j , t ∈ T , r ∈ , j ∈ J \qquad Equation 27$$

The MILP model for CHR-OBASRP is given by Equations 1 through 32 above. The objective function in Equation 1 seeks to minimize the total tardiness. The constraint in equation 2 ensures that the pick location of every item to be retrieved is assigned to be visited by exactly one operator, while the constraint in equation 3 guarantees that each item to be transported is assigned exactly to one AMR tour. Although the AMRs are allowed to make up to |T| tours, they may not need to make all the allowable tours to transport the | [symbol] | items. Therefore, constraints in equations 4 through 5 determine if AMR r makes a nonempty tour t. If no items are assigned to AMR r in tour t, i.e., Σᵢ [symbol] =0), then constraint (equation 4) will ensure that tour t is not made by that AMR (also referred to as an empty tour by forcing X [symbol] zero.

However, if AMR r is assigned to transport at least one item in tour t, i.e., Σᵢ [symbol] ≥1) then constraint (equation 5) will force that AMR to make a nonempty tour t, i.e., [symbol] =1.

In addition, constraint (equation 5) also ensures that the total number of bins required to transport the items collected in an AMR tour does not exceed the AMR capacity κᵣ. Since an AMR is expected to make successive nonempty tours until all items assigned to that AMR are delivered, it is not practical to have an empty tour between two nonempty tours. Thus, constraint (equation 6) is introduced to prevent the AMR from performing a nonempty tour t+1 if that AMR was not assigned to transport any items in the previous tour t. So, when tour t for AMR r is an empty tour, i.e., [symbol] =0, then constraint (equation 6) forces the next tour t+1 for that AMR to be an empty tour as well. However, if AMR r makes a nonempty tour t, then constraint (equation 6) allows the next tour t+1 to either be an empty or nonempty tour.

The relative precedence (or indirect sequencing) between two items, i and i′, assigned to the same operator is ensured using constraints (equations 7-8). Therefore, if items i and i′ are assigned to the same operator k, then constraints (equations 7-8) force either U_{i,i′}^{K}, or U_{i′,i}^{K} will be zero. Likewise, if items i and i′ are transported in the same AMR tour, then their relative precedence (or indirect sequencing) is guaranteed by constraints (equations 9-10).

The retrieval begin time of an item from storage is controlled by constraints (equation 11) and (equation 12). Specifically, the time at which the picker can start retrieving the item is the maximum of two events-(i) travel time from base to the pick location or (ii) time at which the operator can depart the previous pick location plus the travel time to the current pick location. The finish time of the pick operation is the sum of retrieval start time and unload time (including search and pick time), as given by constraint (equation 13). The earliest time at which an operator can leave a pick location is given by constraints (equation 14) and (equation 15). If an item is not assigned to a picker, then he/she cannot perform the pick-and-place operation, and therefore, the corresponding tasks are forced to zero by constraints (equations 16 through 18).

Likewise, the start time of placing item i on an AMR is governed by constraints (Equations 19-21). Specifically, the AMR cannot collect the item before it arrives at the pick location of that item, as given by constraints (equations 19 and 20). In addition, the AMR can collect the item only after the human worker completes the pick operation (constraint (equation 21)). The collection finish time of an item by an AMR is the sum of the collection begin time and loading time and is determined by constraint (22). However, if an item is not assigned to be transported by an AMR in a specific tour, then the related variables are forced to zero by constraints (equations 23 and 24).

The AMR tour completion time (equivalently batch completion time) is determined by constraint (25). On the other hand, constraint (26) ensures that an AMR can begin a tour only after the completion of the previous tour. Since the AMRs are assumed to be ready at the beginning of the picking process, [symbol] , is set to zero in constraint (equation 26) for all AMRs. The delivery completion time of all the items in an order is given by constraint (equation 27), and the corresponding tardiness is determined by constraint (equation 28). Nevertheless, if the AMR does not make a tour, then the start and completion times of the associated tour are restricted to zero by constraint (equation 30). Finally, the non-negativity and binary restrictions on the decision variables are specified by constraints (equations 31 through 32), respectively.

The MILP model can produce an optimal solution in a reasonable time for small instances of CHR-OBASRP. However, given the NP-hard nature of the problem under consideration, the optimization model becomes computationally intractable as the problem size increases. To deal with such instances, we propose a simulated annealing approach with adaptive neighborhood search and optimization-based restarts.

Simulated annealing (SA) is a metaheuristic technique that is often employed to efficiently solve NP-hard combinatorial optimization problems. It is based on the physical annealing process, where the microstructure of a material is altered by gradually cooling it at a higher temperature. In particular, SA uses a local neighborhood search procedure to explore the solution space to the problem, where the following key parameters govern the search processes—initial temperature (θ^{max}), cooling rate (α), and final temperature (θ^{min}).

The algorithm begins with an initial solution v⁰ at temperature θ^{max}, and the associated objective function value is f(v0). In the case of CHROBASRP, a solution refers to the mission and pick lists for all the AMRs and workers, respectively (Mᵣₜ, r∈ [symbol] , t∈T and Pₖ, k∈ [symbol] ), while the objective function value corresponds to the total tardiness Σ_{j∈J}Tⱼ.

To initiate the iterative search process, the current solution (v), objective (f(v)) and temperature (θ) values are set as v⁰, f(v⁰), θ^{max}, respectively. In addition, the best-found solution is also initialized (v*←v⁰, f(v*)←f(v⁰)). At a given iteration l and temperature θ, a candidate solution v′ with objective f(v′) is generated by exploring the neighborhood solutions of v. For a minimization objective, if f(v′)≤f(v), then the neighboring solution is set as the incumbent and best-found solution (i.e., v←v′ and v*←v′). Otherwise, the inferior neighborhood solution is accepted as the incumbent with a certain likelihood. A common acceptance probability function for the SA algorithm corresponds to the metropolis criterion, where a worse solution is accepted as incumbent if a randomly generated number g˜(0, 1)<e(f^{(v)-f(v′)l/θ}. The procedure of exploring the neighborhood solutions and updating the incumbent accordingly is repeated ρ times at each θ. Subsequently, the temperature is reduced by a cooling rate of α, i.e., θ←α×θ). The algorithm is terminated, and the best-found solution along with the objective is returned when one of the following criteria is satisfied: (i) temperature reaches below θ^{min}, (ii) f(v) remains unchanged for the ρ^{max} iterations of the search procedure (iii) f(v) is 0 (since total tardiness cannot be lower than 0). SA allows the exploration of diverse regions by accepting inferior solutions with a probability that decreases steadily with the temperature. It also achieves intensification by always accepting improved solutions.

This is a variant of the traditional SA algorithm called the restarted simulated annealing with adaptive neighborhood search (RSA-ANS). While SA achieves a tradeoff between feasible region exploration and exploitation, the large search space arising due to the three subproblems in CHR-OBASRP requires better strategies for escaping local minima and selecting neighborhood operators. Therefore, unlike the traditional SA, the proposed RSA-ANS uses a restart strategy to escape local optima and an adaptive neighborhood selection mechanism for achieving a time-performance tradeoff. The procedure for RSA-ANS is given in Algorithm 1, shown below. The RSA-ANS requires a set of neighborhood operators along with other parameters in traditional SA as inputs (line 1). A feasible initial solution is generated using a constructive heuristic and is set as the current and best-found solution (lines 2-3). Also, the current temperature and the counter that tracks the total continuous iterations with no improvement (ρ) are initialized (line 3).

Subsequently, the total tardiness associated with the current and best-found solutions is determined (line 4). The outer loop of the RSA-ANS (lines 5-39) forms the core of the local search procedure that progresses by gradually lowering the temperature until one of the termination conditions is met. The inner loop (8-30) is repeated l^{max} times at a given temperature θ, and performs an adaptive neighborhood search to update the current solution. The neighborhood structures considered in this research and their adaptive selection procedure. In particular, at every iteration, the algorithm selects π operators from l^{max} structures and generates neighborhood solutions using them (lines 9-10). The neighborhood solution that yields the lowest tardiness is then selected (lines 11). The current solution is replaced with the best neighborhood solution as per the traditional SA algorithm (lines 13-28). The notable difference is that we use the relative difference between the current and neighborhood solution in the metropolis acceptance criterion as opposed to the absolute difference (line 16), thereby making it dimensionless and independent of the problem specifications. If the solution does not change for ρ^{RS} iterations, then the RSA-ANS employs the optimization-based restart strategy (lines 32-38). Finally, the RSA-ANS returns the best-found solution and the corresponding tardiness value (line 40).

Algorithm 1 Restarted Simulated Annealing with Adaptive Neighborhood Search

| | |
|---|---|
| 1: | Inputs: problem parameters, θ⁰, θ^{min}, α, I^{max}, ρ^{max}, ρ^{RS}, π, N where l = {1, 2, . . . , l^{max}} |
| 2: | generate initial solution (i.e., mission and pick lists), v⁰ |
| 3: | initialize v ← v⁰, v* ← v⁰, θ ← θ⁰, ρ ← 0 |
| 4: | compute f(v) and f(v*) |
| 5: | while θ > θ^{min} and ρ < ρ^{max} and f(v*) ≠ 0 do |
| 6: | I ← 1 |
| 7: | p₁ = 1/1^{max}, ∀l = {1, 2, . . . , l^{max} } |
| 8: | while I ≤ I^{max} and f(v*) ≠ 0 do |
| 9: | choose π operators from {N₁, N₂, . . . , Nₗₘₐₓ} based on selection probability pₗ |
| 10: | generate neighborhood solutions, vₙ, n = 1, 2, . . . , π, using selected operators |
| 11: | compute tardiness of all neighborhood solutions, f(vₙ), n = 1, 2, . . . , π |
| 12: | f(v′) ← min{f(v1), f(v2), . . . , f(vπ)} and v′ ← v′ argmin{f(v1), f(v2), . . . , f(vπ)} |
| 13: | if f(v′) < f(v) then |
| 14: | v ← v′ and f(v) ← f(v′) |
| 15: | else |
| 16: | $Δ = f ( {v}^{′} ) - f ( v ) \frac{f ( v ′ ) - f ( v )}{f ( v )}$ |
| 17: | generate random number g~U(0, 1) |
| 18: | if g ≤ e − Δ/θ, then |
| 19: | update v ← v′ and f(v) ← f(v′) |
| 20: | end if |
| 21: | if f(v′) < f(v*) then |
| 22: | v* ← v′ and f(v*) ← f(v′) |
| 23: | ρ ← 0 |
| 24: | else |
| 25: | ρ ← ρ + 1 |
| 26: | end if |
| 27: | adjust pl of neighborhood operator Nl, where l = {1, 2, . . . , l^{max}} |
| 28: | end if |
| 29: | I ← I + 1 |
| 30: | end while |
| 31: | θ ← α × θ |
| 32: | if ρ ≥ ρ^{RS} then |
| 33: | Use the fix-and-optimize heuristic to find a new restart point v″ |
| 34: | if f(v″) ≠ f(v) then |
| 35: | v ← v″ and f(v) ← f(v″) |
| 36: | ρ ← 0 |
| 37: | end if |
| 38: | end if |
| 39: | end while |
| 40: | return f(v*) and v* |

The complete solution to the CHR-OBASRP includes two parts, which include a mission list of all AMRs and a pick list of all workers. The mission list specifies the items to be picked by AMR r∈ [symbol] in tour t∈T, along with their sequence. On the other hand, the pick list provides the sequence of pick locations to be visited by human workers k∈ [symbol] .

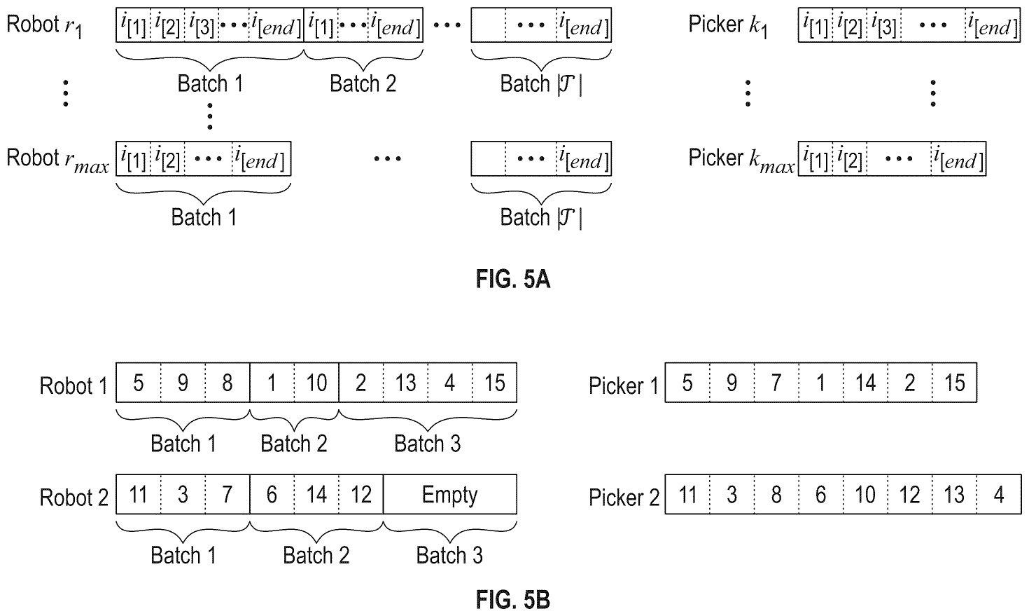

FIG. 5(a) provides a general illustration of the solution to CHR-OBASRP. For example, the third item to be collected by a robot or picker in a trip is denoted as i_{[3]}, and the last item in a trip is represented as i_{[end]}. Therefore, i_{[3]} corresponds to different items in each tour made by the operator and AMR. The total number of items carried in a tour by robot r∈ [symbol] cannot exceed its cart capacity κᵣ.

FIG. 5(b) shows the solution representation for a numerical example, where 15 items are being picked by 2 human workers and transported by 2 AMRs who can each make up to 3 tours. The first robot will collect items 5, 9 and 8 sequentially (i.e., 5→9→8) from their pick locations and return to the depot to complete the first tour. Also, Robot 1 does all three allowable tours, but Robot 2 does only two tours. Since no items are assigned in the third batch for Robot 2, it is represented as an empty tour (i.e., the AMR does not make the third trip). Likewise, Picker 1 will pick-and-place item 5 first and then proceed to the location of item 9 and the remaining item locations in the specified sequence. The picker does not return to the depot for each batch of items collected by the robot, and therefore, the representation of the pick lists does not contain multiple batches.

A rule-based constructive approach is used to generate an initial feasible mission and pick lists for the AMRs and workers, respectively. We adapt the earliest start date heuristic for a human-only OPS to the CHR-OBASRP. Algorithm 2 provides the procedure for generating the initial solution to the CHR-OBASRP. The algorithm uses the problem parameters previously recited as inputs and determines the mission and pick lists (lines 1-2). First, the key variables are initialized, and the items are sorted in ascending order of their due dates (lines 4-5). Subsequently, each item from the sorted listed is sequentially assigned to an operator and robot (lines 6-29). We compute the time at which each worker can reach the pick location from the last position to begin item retrieval (lines 8-10) and assign the operator with the earliest start time to pick the item (lines 11 and 12).

Similarly, the collection begin time for each AMR is calculated based on its travel time from the previous location, and the item is assigned to the AMR with the earliest collection begin time (lines 13-27). Since the AMR's cart capacity is limited, the heuristic ensures feasibility before assigning an item to the AMR (lines 15-24). Once an item is assigned to an operator and robot, it is removed from the list L (line 28). This procedure is repeated until all the items in sorted list L have been removed.

The neighborhood operators facilitate the exploration of the search space by generating new solutions given a feasible solution. In this disclosure, both the mission and pick lists generate a new neighborhood solution. First, we modify the current solution pertaining to the AMR by considering two commonly used search operators such as (i) move (one item is selected from the current solution and shifted to a new position) and (ii) swap (two items from the current solution are selected and interchanged). In particular, we consider the following eight move and swap operators to explore the solution space associated with the AMR.

Algorithm 2 Rule-based heuristic for CHR-OBASRP

```
  1: Input: [symbol]    , J, [symbol]    , [symbol]    , [symbol]    , T, dj, [symbol]    i, [symbol]    , [symbol]    , [symbol]    , [symbol]
  2: Output: mission lists (Mᵣₜ, ∀r ∈ [symbol]    , t ∈ T) and pick lists (Pₖ, ∀k ∈ [symbol]    ′)
  3: Set total items assigned for robot r in trip t to zero, i.e., Γ_{r,t} = 0 ∀r ∈ [symbol]    , ∀t ∈ T)
  4: Initialize Mᵣₜ, ∀r ∈ [symbol]    , t ∈ T, Pₖ, ∀k ∈ [symbol]     and current trip indicator (tᵣ_{^{*}} r, ∀r ∈ [symbol]    )
  5: Create list L by adding items i ∈ ϑⱼ corresponding to order j ∈ J from smallest to largest dⱼ
  6: while [symbol]     ≠ Ø do
  7: Select the first item i1 from L
  8: for each operator k ∈ [symbol]     do
  9: Estimate [symbol]     and [symbol]
10: end for
11: Assign item i₁ to operator k* = argmin/k∈ [symbol] [symbol]
12: Append item i₁ to the end of Pₖ*
13: for each robot r ∈ [symbol]     do
14: Select current trip [symbol]
15: if Γ_{r,t} < κr then
16: Compute collection begin time for robot r in trip t, [symbol]
17: else
18: if tᵣ^{*}< T then
19: Set trip indicator tᵣ^{*} = tᵣ^{*} +1
20: Compute collection begin time for robot r in trip tᵣ^{*}, [symbol]
21: else
22: Set [symbol]     = M, where M is a large positive number
23: end if
24: end if
25: end for
26: Assign item i1 to robot r* = argmin { [symbol]   }
27: Append item i₁ to the end of Mr*, tᵣ^{*}
28: Remove item i₁ from the list L.
29: end while
30: return M_{r,t} and Pₖ
```

N₁: Move an item from a robot tour to a new position in that same tour.
N₂: A randomly selected item transported by a robot is moved to the tour of another robot
N₃: The entire batch of items processed in a tour by an AMR is moved to a new position but still assigned to the same AMR.
N₄: An item is randomly selected and moved to another tour of the same robot.
N₅: Swaps two randomly selected items transported by the same robot but in different tours.
N₆: Two items assigned to different AMRs are randomly selected and swapped.
N₇: Two randomly selected tours made by the same robot are interchanged.
N₈: Swaps two randomly selected items within a robot tour.

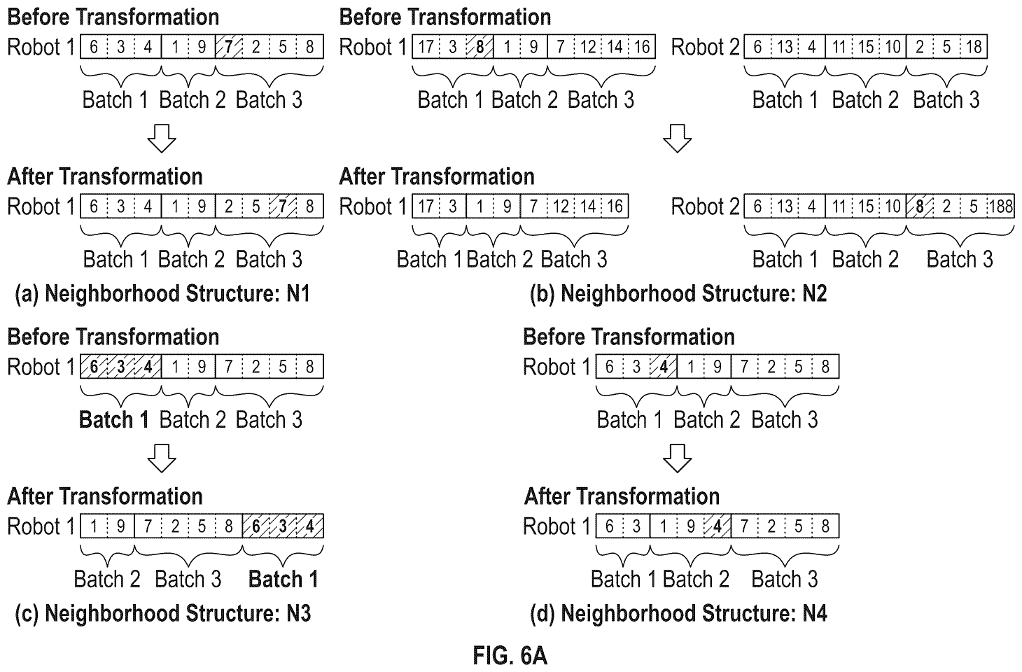

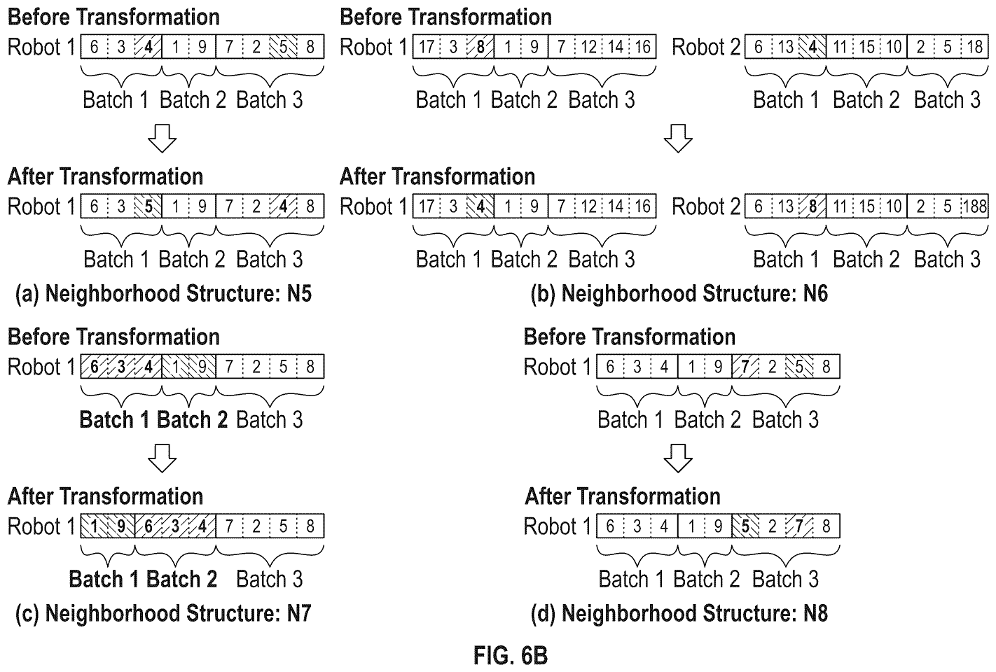

FIGS. 6(a) and 6(b) provide an illustrative example of the different move and swap neighborhood structures, respectively. It is important to note that the eight operators are designed to ensure that all the subproblems associated with the AMR (order batching, tour assignment and sequencing, AMR routing) are feasible when a neighborhood solution is generated. For instance, neighborhood structure Ni will not move an item to a tour if such transformation will result in a nonempty tour after an empty tour. In other words, the eight neighborhood structures will identify all possible feasible moves/swaps and will randomly select one among them to generate a feasible neighborhood solution.

Subsequently, the current operator plan is modified while taking into account the new neighborhood solution for the AMR. Otherwise, the solution to the problem can become infeasible. For example, an AMR might be scheduled to visit items in the following sequence: 1→7→5 in tour 1. However, the picker's plan could be items 1→5→7, thereby making the solution to the CHR-OBASRP infeasible since AMR will continue to wait at pick location 7 for the human worker, while the picker will be waiting at pick location 5 for the AMR. The overall solution to the problem can be made feasible in many ways, such as swapping items 5 and 7 for the worker or reassigning items 5 or 7 to another picker. Thus, given the new neighborhood solution for the AMR, the current operator plan is updated by identifying all possible items that can be moved or reassigned and randomly selecting a feasible operation.

Adaptive selection of neighborhood operators, where given a set of lmax neighborhood structures (N₁,N₂, . . . ,Nₗ^{max}), the RSA-ANS selects It operators (where π≥l^{max}) to generate multiple neighborhood solutions. Evaluating all the operators at each iteration (i.e., π=l^{max}) may allow the exploration of many neighboring solutions but increases the computational complexity as l^{max} increases. On the other hand, randomly selecting a few neighborhood operators at every iteration may not efficiently guide the search toward promising solution regions. Therefore, to achieve a performance-efficiency tradeoff, it is important to strategically select the operators at a given iteration. The success of a neighborhood structure depends on several factors, such as problem instances and current solutions. Therefore, a neighborhood operator could achieve improved objective value during initial iterations of the local search procedure but may not find good solutions as the algorithm progresses. Therefore, the only mechanism to select a well-performing neighborhood operator at a given temperature is through dynamic adjustments of their selection probability. In this research, we adaptively select π operators based on their successful performance in previous iterations. A selection weight will be assigned for each operator and is initialized to be the same for all operators. Subsequently, the weights are updated at every iteration of a given temperature according to Equation 33, where ξ denotes the minimum weight assigned to all operators and ϕₗ represents the number of iterations in which the selected operator was accepted as the current solution.

$$wl = ξ + ( 1 - {l}^{max} \times ξ ) \times \frac{Φ 1}{\sum Φ1} ∀ l = 1 , 2 , , {l}^{max} \qquad Equation 33$$

To select the π operators in an iteration, a roulette-wheel selection principle is used, where a neighborhood operator Nl has a selection probability pl, as given by Equation 34. Note that the operators are selected without replacement, and therefore, the same operator cannot be chosen twice.

$${p}_{l} = \times \frac{wl}{\sum lwl} , ∀ l = 1 , 2 , … , {l}^{max} \qquad Equation 34$$

In order to randomize the search procedure and provide an equal chance to all operators in the later stages, the weights and selection probabilities are reset after γ temperature reductions.

Fix-and-optimize heuristic as restart strategy where during the search process, if f(v) does not change for ρ^{max} continuous temperature reductions, then we adopt a fix-and-optimize heuristic strategy to escape local minima and update the current solution v. The fix-and-optimize heuristic seeks to fix specific binary variables in the MILP model and solve for the remaining decision variables to obtain a new solution. We consider the following two cases to fix the binary variables.
Case 1: The binary variables associated with the pick list {Pₖ, k∈ [symbol] } of the current solution v are fixed, and the mission list {Mᵣₜ, r∈ [symbol] , t∈T} of v is used to warm-start the model. Subsequently, the MILP model is solved to optimize the mission list {Mᵣₜ, r∈ [symbol] , t∈T}. This will lead to a new solution v′ with an updated mission list {Mᵣₜ^{new}, r∈ [symbol] , t∈T} and objective value f(v′).
Case 2: The binary decision variables pertaining to {Mᵣₜ, r∈ [symbol] , t∈T} of v are fixed, while {Pₖ, k∈ [symbol] } is used to warm-start and solve the MILP model. This results in an updated solution v′ with objective value f(v′) and a new pick list {Pₖ^{new}, k∈ [symbol] }.

To restart the algorithm, one of the two cases is randomly selected to replace the current solution v and the corresponding objective value with v′ and f(v′), respectively. The potential advantages of the proposed restart mechanism are as follows. First, a new solution can be found even for very large instances by terminating the optimization model after a certain time limit. In other words, it is not necessary to solve the MILP model optimally, especially when it is expected to slow the computational time for RSA-ANS substantially. Second, as opposed to a random restart, the proposed approach is guaranteed to yield an objective value that is better than or equal to the current f(v). Finally, leveraging the optimization model is likely to direct the restart point to more promising solution regions. Performance evaluation of RSA-ANS where the solution quality obtained by the proposed RSA-ANS is evaluated by comparing it with the variable neighborhood descent (VND) algorithm, which is a metaheuristic approach that was known to provide high-quality solutions to the OBASRP problem for a conventional human-only OPS. An overview of the VND procedure is given in Algorithm 3. The algorithm requires parameters associated with the CHR-OBASRP instance and the different neighborhood operators as inputs (line 1). Similar to RSAANS, the initial solution is generated using the constructive heuristic and the corresponding total tardiness is determined (line 2). The best-found solution, the best tardiness value, and the current neighborhood operator are initialized at the beginning of the search procedure (line 3). The loop (lines 4-12) seeks to sequentially explore the best neighborhood solution pertaining to each operator and terminates the VND procedure only when the current best solution (v*) cannot be improved by any of the Imax operators. For the chosen operator l, the algorithm searches for the best neighborhood solution (i.e., lowest total tardiness value). If an improved solution is identified through local search, then it is accepted as the current best solution and the neighborhood operator is reset to 1 (lines 6-8). Otherwise, the next neighborhood operator (l+1) is explored. Upon termination, the best-found solution and corresponding tardiness value are returned (line 13). In addition to VND, we also consider the simulated annealing with adaptive neighborhood search (SA-ANS), which follows the same procedure as the proposed RSA-ANS but without the restart strategy. This would allow us to investigate the impact of using an optimization-based restart strategy on the solution quality.

Algorithm 3 Variable Neighborhood Search

| | |
|---|---|
| 1: | Inputs: problem parameters and Nₗ, where l = {1, 2, . . . , l^{max}} |
| 2: | generate initial solution (v⁰) and compute corresponding total tardiness ƒ (v⁰) |
| 3: | initialize v* ← v0, ƒ (v*) ← ƒ (v⁰), and l ← 1 |
| 4: | while l ≤ l^{max} do |
| 5: | find best neighborhood solution v′ for operator Nₗ(v) and determine ƒ (v′) |
| 6: | if ƒ (v′) < ƒ (v*) then |
| 7: | v* ← v′ and ƒ (v*) ← ƒ (v′) |
| 8: | l = 1 |
| 9: | else |
| 10: | l ← l + 1 |
| 11: | end if |
| 12: | end while |
| 13: | return ƒ (v*) and v* |

Numerical experiments, where in this section, we validate the proposed MILP model for CHROBASRP for small problem instances and also leverage the optimal solution to evaluate the performance of the metaheuristic approaches, namely VND, SA-ANS, and RSA-ANS. In addition, extensive numerical analysis is conducted to (i) assess the impact of adopting the fix-and-optimize restart strategy, (ii) benchmark the solution quality of RSA-ANS against VND since it was commonly used in prior works for efficiently solving OBASRP, (iii) gain insights on the impact of human-robot composition, AMR speed, AMR cart capacity, and warehouse layout on total tardiness. To conduct the analysis, we generate test instances. The parameter tuning procedure for the metaheuristic approaches and the results are presented below. The proposed MILP model is coded using the Gurobi Python™® interface, and the metaheuristic approaches are developed using Python™ 3.9. All experiments are executed on a desktop with an Intel® Core-i9 processor and 128 GB RAM. Intel® is a registered trademark of the Intel Corporation, and it has a place of business at 2200 Mission College Blvd., Santa Clara, California.

For the generation of problem instances, we generate realistic test instances by setting the warehouse attributes. Specifically, a single-block warehouse with 20 storage racks is considered, where each rack is 20 ft long, and each storage location is 1 ft wide by 5 ft. decp. The racks are arranged in parallel such that the picking area is divided into 10 five-foot-wide picking aisles and 2 horizontal cross-aisles. Each picking aisle provides access to 40 storage locations (i.e., each side of the aisle has 20 racks), thereby resulting in a total of 400 storage locations. In addition, a single depot (or drop-off station) is located in the middle of the front horizontal cross-aisle. To create a test instance, we randomly generate | [symbol] | item locations based on the 400 storage positions. For generating small test instances, we consider a total of 10 or 15 items split among 5 and 7 orders, respectively. Likewise, the total items are fixed to 50 or 100 to generate larger instances. Also, our experimentation explores four different levels of human-robot team compositions (kmax, rmax) for collaborative order picking—(1,1), (2,1), (1,2) and (2,2) for small instances, and (2,2), (4,2), (2,4) and (4,4) for larger instances. For the baseline setting, we set the AMR cart capacity and travel speed to 20 items and 2 feet/second, respectively. On the other hand, human pickers walk at a speed of 1 foot/second. These speeds and warehouse configurations are used to establish the travel time of the AMRs and workers within the warehouse (e.g., depot to a storage location, storage location of one item to another). The item retrieval time for a human worker is 0.75 seconds, and the time taken to place it on the AMR is also 0.75 seconds.

To generate the due dates, we adapt the procedure followed by previous work on traditional human-only OPS. Specifically, the generation of due dates depends on four factors that include the pick completion time of order j (Ĉⱼ) when it is the only order processed in a tour, available AMRs (rₘₐₓ) and pickers (kₘₐₓ), and the modified traffic congestion rate (γ), a parameter that affects due date tightness. Given these four factors, the due date [associated with order j∈J is randomly generated from the interval [Ĉ, ₍2·(1−γ)Σ_{j∈J} Ĉⱼ+minⱼ∈_{J} Ĉ,)/min {kₘₐₓ, rₘₐₓ}]. The value of γ is set at 0.6, 0.7 or 0.8. In this research, a problem class is established based on three parameters, namely, [symbol] , (kmax, rₘₐₓ), and γ. Based on the above-described values of these three parameters, we generate 12 different problem classes for both small (| [symbol] |=10 and 15) and large cases (| [symbol] |=50 and 100). Besides, we generate 10 instances for each problem class, thereby resulting in a total of 12·10·4=480 instances. In addition, the large problem settings (240 instances) are also considered to assess the impact of AMR capacity, AMR speed, and multi-block warehouse layouts.

TABLE 2
Parameters and explored levels for SA-ANS and RSA-ANS.

| Parameter | Values explored |
|---|---|
| θ min | 10, 20, 30 |
| α | 0.90, 0.95, 0.99 |
| ρₘₐₓ | 10 · [symbol] , 15 · [symbol] , 20 · [symbol] |
| ρRS (applies only to RSA-ANS) | 5.10, 15 |
| π | 3, 4, 5 |

Parameter setting for metaheuristic approaches under study, where the solution quality of SA-ANS and RSA-ANS depends on their hyperparameters. We established the initial temperature (θ0) based on the slightly modified metropolis criteria that use the relative difference between the current and neighboring objective values. Specifically, we set θ⁰ as 475 since it allows the algorithm to accept solutions that are 50% worse than the current solution with a probability of 0.9 (i.e., θ⁰=−50/logₑ(0.9) based on metropolis criteria).

Furthermore, the epoch length (l^{max}) is fixed at 30 since it is considered a statistically good sample. Given a set of potential values for each parameter, their procedure evaluates different combinations of these values. It selects the setting that achieves the best performance for a representative set of sample instances. In particular, we sequentially vary the value of a specific parameter while fixing the other to assess the impact of that parameter. The parameter values explored for SA-ANS and RSA-ANS are based on an initial empirical analysis and are given in Table 2. The parameters that produced the best performance values are as follows: θmin=20, α=0.95, ρ^{max}=10·51 [symbol] |, ρ^{RS}=5 and π=3. On the other hand, the VND algorithm does not contain parameters that require tuning.

Results of exact and metaheuristic approach applied to small instances, where in this section, we solve the proposed MILP model and verify the solution obtained. To assess the accuracy and correctness of the MILP model, we manually compute performance measures based on the optimal value of the decision variables and compare them against the solution obtained. We found the two solutions (manually computed versus randomly selected. model output) to be in complete agreement with the small instances that are randomly selected.

Furthermore, we also evaluated the model for certain edge cases to ensure that it generated the expected solution. For instance, when the due date of all orders is set to zero, and the total items to be collected are less than the AMR cart capacity, the optimal solution is expected to utilize all the available resources and make only one tour for each AMR. Likewise, all orders are likely to be delivered to the depot without any tardiness if their due date is set to be very high. The performance of the proposed MILP model is observed to be as expected for these extreme cases. Subsequently, the three metaheuristic approaches are also used for solving all the small instances, and their performance is compared against the optimal solution. Table 3 summarizes the results of the MILP model and also provides the relative percentage deviation (RPD) between the solution obtained by each metaheuristic approach and the MILP model.

The RPD is calculated as 100·(Zₛ−Z*)/Zₛ, where Zₛ is the best total tardiness achieved by solution approach s∈{VND, SA-ANS, RSA-ANS} and Z* is the optimal total tardiness. The computing time required to achieve the best solution is referred to as the CPU time. The MILP solver is terminated after 7200 s. The MILP model is able to achieve the optimal solution for all the instances involving 10 and 15 items. As expected, the total tardiness and computing time increases substantially when | [symbol] | is increased from 10 to 15. A similar trend is observed when the human-robot composition or due date tightness (γ) is increased.

With respect to the human-robot composition, the reduction in total tardiness appears to be highest when kmax is increased. For example, when (kmax, rmax) is changed from (1,1) to (2,1) for |·|=10, the total tardiness reduces by 60%, 65% and 60% for γ of 0.6, 0.7 and 0.8, respectively. On the other hand, increasing the available AMRs instead of human workers (i.e., adjusting human-robot composition from (1,1) to (1,2)) for | [symbol] |=10 yields 24%, 27%, and 26% improvement in tardiness for γ of 0.6, 0.7 and 0.8, respectively. This finding could be attributed to the slower travel speeds of pickers compared to AMRs. In other words, increasing the resource with slower speeds has the potential to reduce the AMR wait time at a pick location, which, in turn, reduces the completion time of a batch (and associated tardiness).

The results in Table 3 also indicate superior performance of the three metaheuristic approaches as the average RPD from optimal is less than 1%, and the CPU time is considerably less than the exact approach. Among the three metaheuristics, the proposed RSA-ANS achieved the best tardiness value since it yielded the optimal solution in most cases (14 out of 24 problem classes) and resulted in the lowest average RPD of 0.05%. The SA-ANS and VND have an average RPD of 0.33% and 0.875%, respectively. This suggests that the proposed fix-and optimized restart strategy in RSA-ANS has enabled it to achieve better solution quality. Since RSA-ANS has an additional module pertaining to the restart strategy, its CPU time is slightly higher than SA-ANS and VND. Thus, the analysis of small instances demonstrates the ability to achieve near-optimal solutions by all three algorithms and highlights the dominance of RSA-ANS. Our empirical analysis also revealed that the computing time of the MILP model increases exponentially as | [symbol] | increases, and the MILP solver is unable to find the optimal solution for | [symbol] |=20 within the runtime threshold of 7200 S.

TABLE 3
Performance comparison of metaheuristic approaches against the exact approach.

| | | | | SA- | RSA- | | |
|---|---|---|---|---|---|---|---|
| [symbol] | (kₘₐₓ, rₘₐₓ) | γ | VND | ANS | ANS | Δ_{VND} | Δ_{SA-ANS} |
| 50 | (2, 2) | 0.6 | 438 | 408 | 376 | 14.17% | 7.85% |
| 50 | | 0.7 | 1848 | 1720 | 1637 | 11.42% | 4.85% |
| 50 | | 0.8 | 3168 | 2973 | 2825 | 10.82% | 4.98% |
| 50 | (4, 2) | 0.6 | 112 | 108 | 101 | 10.43% | 6.92% |
| 50 | | 0.7 | 471 | 438 | 409 | 13.14% | 6.65% |
| 50 | | 0.8 | 1045 | 1009 | 931 | 10.83% | 7.72% |
| 50 | (2, 4) | 0.6 | 131 | 121 | 113 | 14.39% | 7.01% |
| 50 | | 0.7 | 538 | 494 | 459 | 14.56% | 7.09% |
| 50 | | 0.8 | 1564 | 1407 | 1313 | 16.06% | 6.68% |
| 50 | (4, 4) | 0.6 | 77 | 69 | 65 | 15.52% | 5.97% |
| 50 | | 0.7 | 208 | 198 | 179 | 13.99% | 9.58% |
| 50 | | 0.8 | 674 | 626 | 582 | 13.66% | 6.99% |
| 100 | (2, 2) | 0.6 | 792 | 772 | 706 | 10.90% | 8.66% |
| 100 | | 0.7 | 3999 | 3653 | 3366 | 15.83% | 7.86% |
| 100 | | 0.8 | 10438 | 9594 | 8810 | 15.60% | 8.16% |
| 100 | (4, 2) | 0.6 | 313 | 299 | 283 | 9.58% | 5.35% |
| 100 | | 0.7 | 1137 | 1115 | 1032 | 9.23% | 7.42% |
| 100 | | 0.8 | 3431 | 3294 | 3027 | 11.77% | 8.10% |
| 100 | (2, 4) | 0.6 | 354 | 343 | 318 | 10.17% | 7.29% |
| 100 | | 0.7 | 1494 | 1414 | 1286 | 13.92% | 9.08% |
| 100 | | 0.8 | 5422 | 4821 | 4555 | 15.98% | 5.52% |
| 100 | (4, 4) | 0.6 | 214 | 196 | 181 | 15.42% | 7.65% |
| 100 | | 0.7 | 507 | 493 | 456 | 10.04% | 7.63% |
| 100 | | 0.8 | 2362 | 2248 | 2033 | 13.93% | 9.59% |

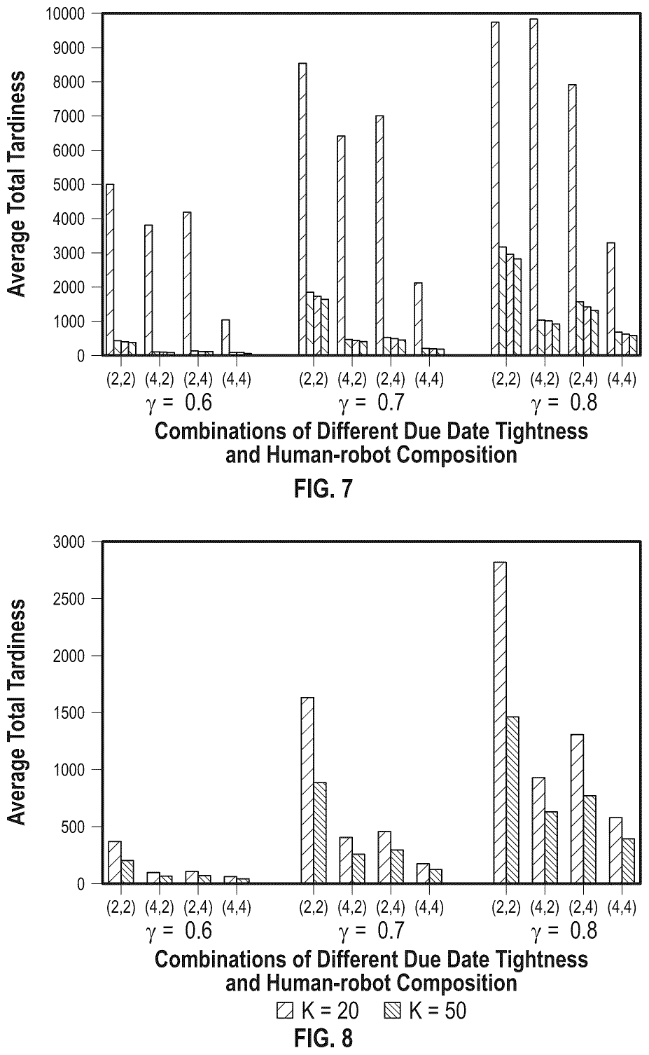

To evaluate the performance of the MILP solver for relatively large instances, we solved it for instances involving 50 items. FIG. 7 compares the solution obtained by the MILP model (after 7200 s) with the three metaheuristic approaches. The time taken by VND, SA-ANS, and RSAANS to obtain the least tardiness values is less than 1800 s. It can be seen that the MILP model produced solutions of inferior quality. For example, the RSA-ANS algorithm achieves improvements ranging from 71% (γ=0.8 and (kₘₐₓ, rₘₐₓ)=(2, 2)) to 91% (γ=0.6 and (kₘₐₓ, fₘₐₓ)=(4, 2)). We conclude that the exact approach is not suitable for obtaining good solutions in practice, especially when | [symbol] | exceeds 20.

Performance evaluation of proposed RSA-ANS for large instances. The performance of VND, SA-ANS and RSA-ANS for the problem class pertaining to large instances (| [symbol] |=50 and 100) is presented in Table 5. This includes the average total tardiness for the CHR-BASRP obtained by the three metaheuristic approaches and the solution quality of the proposed RSA-ANS. Specifically, ΔVND provides the percentage improvement achieved by RSA-ANS over VND, while ΔSA-ANS demonstrates the benefit of employing the fix-and-optimize restart strategy. Similar to the findings for small instances, the total tardiness for all problem classes increases substantially with γ. Also, increasing the availability of relatively slower-speed resources (i.e., pickers) yields the highest reduction in average total tardiness.

It is also evident that RSA-ANS obtains the lowest average total tardiness for all the problem settings under consideration. Compared to VND, the proposed RSA-ANS achieves an average improvement (ΔVND) of 13.25% and 12.70% for instances with 50 and 100 items, respectively.

With respect to the four robot-human compositions, the average reduction in total tardiness is consistent and ranges between 12% and 14%. For γ of 0.6, 0.7 and 0.8, the RSA-ANS outperforms VND by 12.57%, 12.77% and 13.57%, respectively. Thus, it is apparent that the proposed RSA-ANS is able to outperform the VND algorithm, which was shown to yield good solution quality for a conventional human-only for all large instances.

The results also establish the significance of the fix-and-optimize restart strategy. As substantiated by ASA-ANS, the average total tardiness obtained without the proposed restart mechanism (i.e., SA-ANS) is 6.86% and 7.70% higher for problem instances with | [symbol] =50| and 100, respectively. For different values of both (kmax, rmax) and y, the total tardiness obtained by RSA-ANS is consistently between 7%-8% lower than SA-ANS.

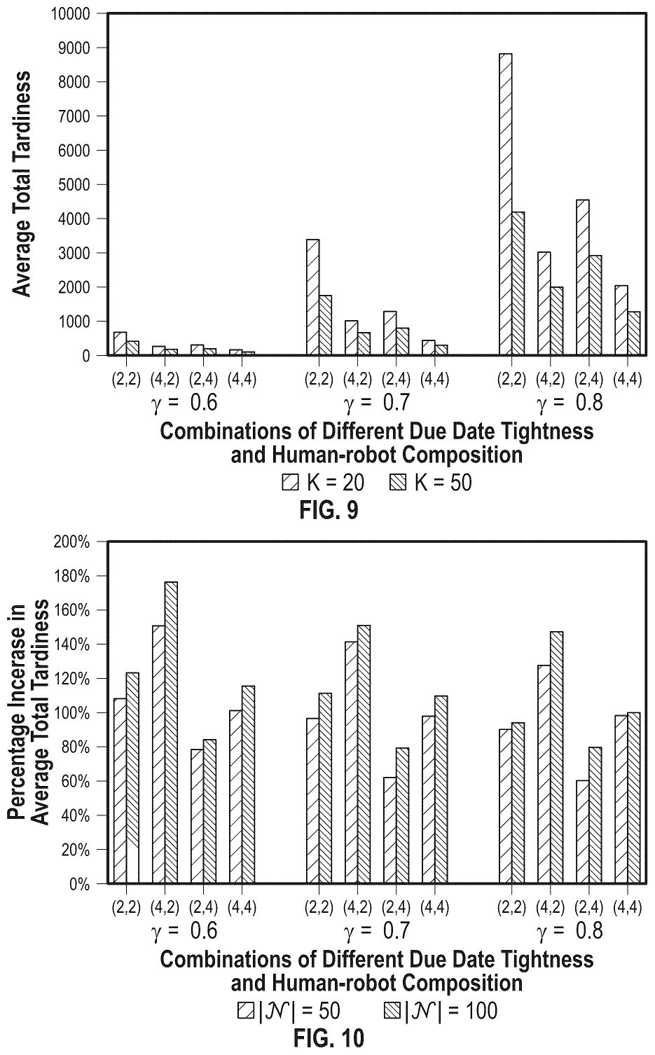

The impact of AMR cart capacity is that the capacity of the AMR cart (κ) was restricted to 20 items in the baseline analysis of large instances. To assess its sensitivity to total tardiness value, we increase κ to 50 and obtain the solution for the large problem class using the proposed RSA-ANS. FIGS. 8 and 9 illustrate the impact of AMR cart capacity for instances with 50 and 100 items, respectively. It is clear that the average total tardiness decreases considerably as the AMR cart capacity increases. The percentage reduction in total tardiness increases as due date tightness is increased (i.e., varying y from 0.6 to 0.8). Specifically, in the case of | [symbol] |=50, increasing the AMR cart capacity from 20 to 50, improves the average total tardiness by 49%, 60%, and 64% for y of 0.6, 0.7 and 0.8, respectively. The improvement achieved is even greater for instances involving 100 items—54%, 62%, and 68% for γ of 0.6, 0.7 and 0.8, respectively. Likewise, increasing the AMR cart capacity also improved the total tardiness of the different robot-human team compositions to varying degrees. The reduction in total tardiness is highest when (kmax, rmax) is (2,2). It is about 85% and 90% for instances involving 50 and 100 items, respectively. Nevertheless, if (kmax, rmax) is set as (4,2) and (2,4), the average improvements are around 51% and 56% (for both 50 and 100 item instances), respectively.

On the other hand, when the available robots and pickers are increased to four, the improvement in total tardiness is reduced to 38% and 45% for | [symbol] | of 50 and 100, respectively. Overall, it is observed that increasing the AMR cart capacity from 20 to 50 is beneficial, especially for instances with 100 items, tighter due dates, or fewer AMRs. This could be attributed to the number of tours made by the AMRs. With a higher cart capacity, each AMR would have to make fewer trips back to the depot before completing all the orders, which, in turn, decreases the total tardiness. Furthermore, we also investigated the number of 20-bin AMRs and pickers required to achieve the same level of performance yielded by employing 50-bin AMRs. As expected, more resources are needed when employing low-capacity AMRs. For both | [symbol] |=50 and 100, three 20-bin AMRs and four pickers are required to achieve similar results obtained by two 50-bin AMRs and two pickers. Likewise, the performance achieved by four 20-bin AMRs and four pickers is similar to that of two 50-bin AMRs and three pickers. Thus, given the AMR capacity, the proposed solution approach can also be used to determine the human-robot composition required to achieve a specific service level.

The Impact of AMR speed is that the initial analysis considered the AMR travel speed to be 2 ft/s. In this section, we analyze the impact of AMR travel speed on overall order-picking performance. We evaluate the percentage change in the average total tardiness when the AMR speed is changed (decreased and increased) by 1 ft/s from its baseline value.

FIG. 10 illustrates the percentage increase in the average total tardiness for all large problem classes when the AMR speed is decreased from 2 ft/s to 1 ft/s (i.e., 50% reduction). In other words, in this setting, both the picker and AMR travel at the same speed. It can be observed that the average tardiness increases substantially (min: 61%, average: 108%, max: 176%) for all the problem classes under consideration. Its impact is slightly higher, for instance, with 100 items, and this is expected as AMRs may have to make more tours to process all orders.

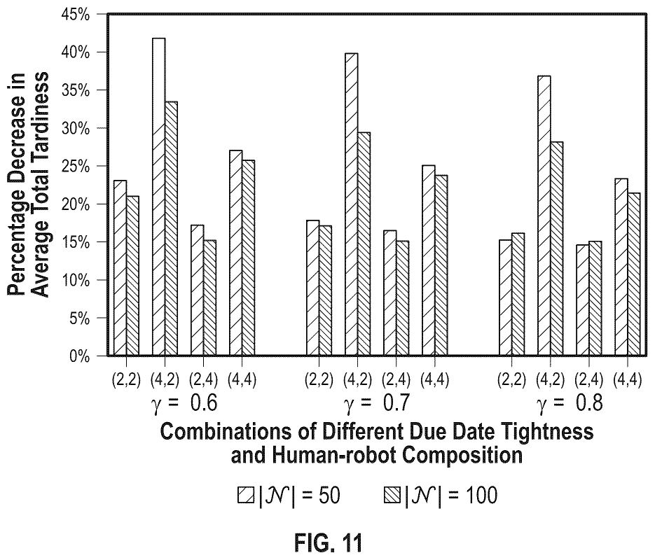

Additionally, the percentage increase in the average total tardiness gradually decreases as the due date tightness (γ) is increased. With regards to human-robot team composition, the highest percentage increase in tardiness occurs when (kₘₐₓ, rₘₐₓ) is (4,2), where the values obtained are about 2.5-3.5 times more than the baseline setting. On the other hand, settings with four robots and two pickers had the lowest impact on tardiness. For cases with an equal number of pickers and robots, the percentage increase was about two times the baseline values. FIG. 11 shows the impact of increasing AMR speed from 2 ft/s to 3 ft/sec. Note that the AMR now travels three times faster than the picker. Although the average total tardiness improves compared to the baseline results (i.e., Table 4), the percentage change is not substantial (min: 15%, average: 23%, max: 42%) given that the speed is increased by 50%.

The improvement achieved is slightly lower for settings with 100 items or higher due-date tightness. A collaboration among four pickers and two AMRs achieves the highest improvement, whereas employing fewer AMRs than pickers led to the least improvement.

These results (as shown in FIG. 11) confirm that the AMR speed affects the order-picking performance, but its influence is also dependent on the picker speed. Specifically, the findings suggest that it is beneficial to have an AMR that travels faster than the picker but also exhibits the law of diminishing marginal utility. In other words, when the picker speed is fixed, the percentage improvement derived from each unit increase in AMR speed decreases. Besides, the results also suggest an interaction between robot-human team composition and AMR speed. If the AMR travels faster than the picker, then it may be beneficial to employ fewer AMRs than pickers.

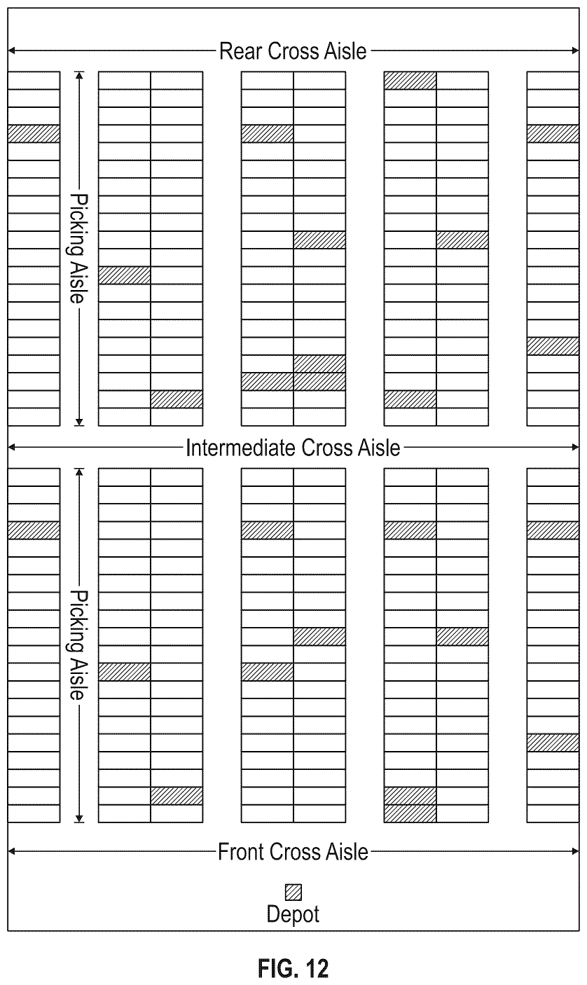

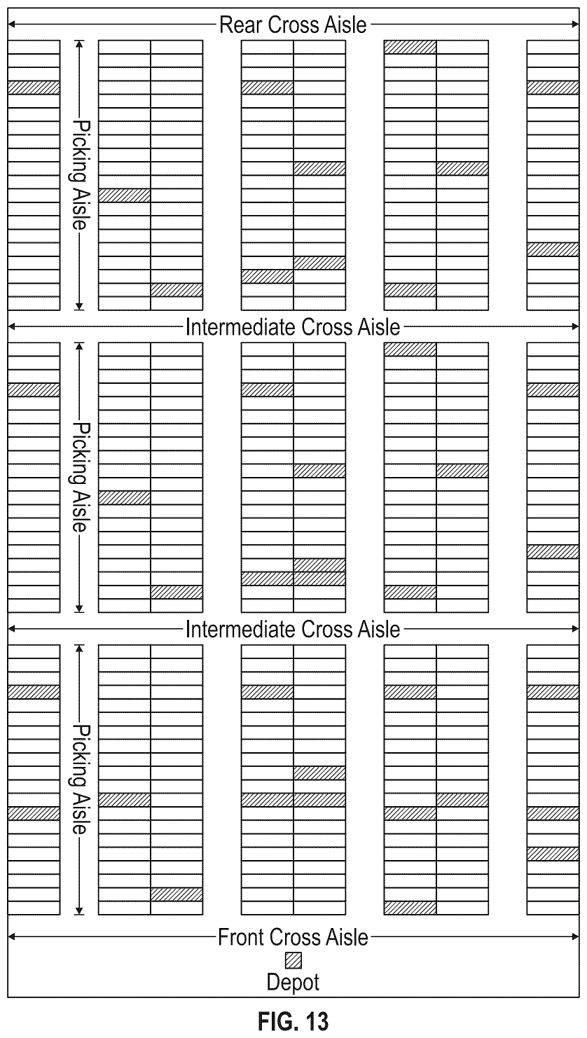

The impact of a multi-block warehouse layout is that the analysis in the previous subsections considered a single-block warehouse layout since it is most commonly studied in the literature. However, in practice, warehouses dealing with a large volume and variety of items typically adopt a multi-block layout with intermediate cross aisles. Nevertheless, the proposed approach applies to any warehouse layout because it requires only the distance between the item locations within the warehouse, and this information can be easily calculated for any layout. This section considers two-block and three-block warehouse layouts and uses the proposed RSA-ANS approach to solve instances involving 50 and 100 items. As shown in FIGS. 12 and 13, an intermediate cross aisle separates the blocks in multi-block warehouse layouts. Similar to the baseline setting discussed previously, each block has 20 racks and 400 storage locations. Besides, the dimensions of the rack and storage locations are set to be the same as a single-block layout. Therefore, a two-block layout has 40 racks (800 storage locations), shown in FIG. 12, and a three-block layout has 60 racks (1200 storage locations), shown in FIG. 13. All the remaining settings are set to the baseline value.

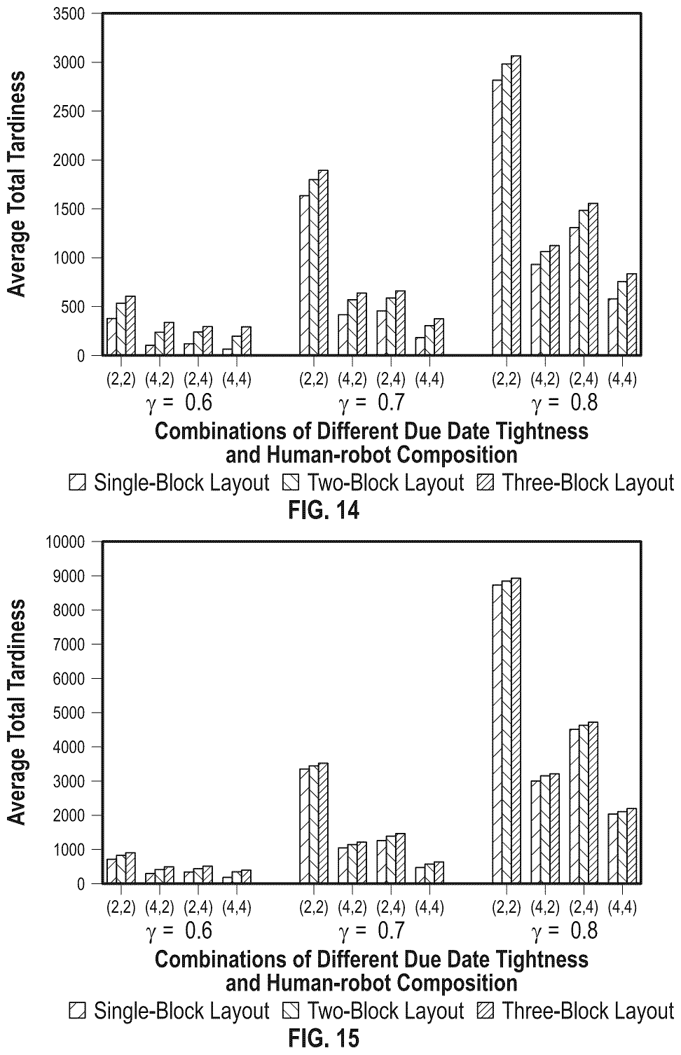

FIGS. 14 and 15 compare the tardiness value pertaining to different warehouse layouts for 50 and 100-item instances, respectively. The impact of due-date tightness (γ) and human-robot composition on total tardiness is similar for the three layouts. In other words, irrespective of the warehouse layout, the tardiness values increase as the due-date tightness increases. Likewise, increasing the number of pickers (slower resource) leads to the greatest improvement in tardiness. We can also observe that the tardiness value increases with the number of blocks. This is expected because the distance traveled by the AMRs and pickers is likely to increase as the warehouse size (number of blocks and cross aisles) increases. Thus, the results suggest that the impact of warehouse layout on tardiness is not negligible. Further, it also demonstrates the capability of the proposed solution approach to handle multi-block layouts.

In summary, a collaborative order picking system (OPS), where human workers retrieve orders from warehouse storage and autonomous mobile robots (AMRs) transport them from the picking area to the depot, involves three subproblems associated with a multi-human, multi-robot OPS, and introduces the Collaborative Human-Robot Order Batching, batch Assignment and Sequencing, and picker-robot Routing Problem (CHR-OBASRP). A mixed integer linear programming model with the objective of minimizing the total tardiness is developed to solve the CHR-OBASRP to optimality. To deal with the computational intractability of the optimization model, a restarted simulated annealing algorithm with adaptive neighborhood search (RSA-ANS), which integrates an adaptive multi-neighborhood search and fix-and-optimize restart technique with simulated annealing. Extensive numerical analysis showed that the RSA-ANS is able to achieve the optimal or near-optimal (within 0.2%) solution for all the small problem instances. Besides, the proposed RSA-ANS achieved superior solution quality for larger instances and outperformed the variable neighborhood descent (VND) algorithm with an average improvement of about 13%. In addition, employing the proposed optimize-and-fix restart strategy yields about 7% lower tardiness, suggesting its capability to escape local optima. Our results also provided several practical insights on CHROBASRP, particularly the influence of AMR cart capacity, AMR speed and human-robot team composition. The new variant of the collaborative order-picking approach introduced can be extended in numerous ways. First, we can integrate the fleet optimization decision into the CHR-OBASRP since human-robot team composition has a substantial impact on total tardiness. Second, a comparative analysis of different warehouse layouts, pick strategies (e.g., zone picking vs. cluster picking), and human-robot routing strategies (e.g., picker-in lead vs. swarm) can be conducted to assess their influence. Moreover, a dynamic system in which the order requests arrive sequentially over time, thereby requiring real-time adjustments to the decisions associated with CHR-OBASRP, would be helpful. Finally, other objectives should be considered, e.g., minimizing the picker's travel distance) as well as tradeoffs among multiple conflicting objectives (e.g., minimizing operating cost vs. makespan).

### GLOSSARY

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein, refers to slight variations in numerical quantities with respect to any quantifiable variable. An inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes a structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations. subcombinations, or the like that would be obvious to those skilled in the art.

What is claimed is:

1. A computerized warehouse management system for managing a warehouse with a human-autonomous mobile robot order picking system, the computerized warehouse management system comprising:
at least one processor and memory in communication with the at least one processor, wherein the computerized warehouse management system is programmed to perform operations including determining how many items should be collected in each tour of the at least one autonomous mobile robot, assigning batches to the at least one autonomous mobile robot, and develop coordinated routing of the at least one autonomous mobile robot and the associated human picker that is then followed by:
(a) directing at least one autonomous mobile robot of a plurality of autonomous mobile robots to a location of a first item in a batch of items from an initial location;
(b) determining if a human picker has arrived at that location;
(c) receiving an item from the human picker by the at least one autonomous mobile robot;
(d) directing the at least one autonomous mobile robot to move to the location of the next item in the batch and repeat steps (b)-(c);
(e) determining if all programmed tours of the at least one autonomous mobile robot have been completed and if not, then repeat steps (a)-(d); and
(f) directing at least one autonomous mobile robot of a plurality of autonomous mobile robots to return to the initial location upon completion of step (e).

2. The computerized warehouse management system for managing a warehouse with a human-autonomous mobile robot order picking system, according to claim 1, wherein a number of items for pickup by the at least one autonomous mobile robot is optimized for a tour for each batch with the at least one processor.

3. The computerized warehouse management system for managing a warehouse with a human-autonomous mobile robot order picking system, according to claim 1, wherein each batch assignment for each autonomous mobile robot is optimized with the at least one processor.

4. The computerized warehouse management system for managing a warehouse with a human-autonomous mobile robot order picking system, according to claim 1, wherein the routing of the at least one autonomous mobile robot and the associated human picker minimizes picking time with the at least one processor.

5. The computerized warehouse management system for managing a warehouse with a human-autonomous mobile robot order picking system, according to claim 1, wherein a speed of the at least one autonomous mobile robot is determined by the processor to optimize efficiency with the at least one processor.

6. The computerized warehouse management system for managing a warehouse with a human-autonomous mobile robot order picking system, according to claim 1, wherein an item holding capacity of the at least one autonomous mobile robot is determined by the processor to optimize efficiency with the at least one processor.

7. The computerized warehouse management system for managing a warehouse with a human-autonomous mobile robot order picking system, according to claim 1, wherein a combination of the at least one autonomous mobile robot and associated human picker is evaluated by the processor to optimize efficiency with the at least one processor.

8. The computerized warehouse management system for managing a warehouse with a human-autonomous mobile robot order picking system, according to claim 1, wherein a combination of the at least one autonomous mobile robot and associated human picker in combination with a warehouse layout is evaluated with the processor to optimize efficiency with the at least one processor.

9. The computerized warehouse management system for managing a warehouse with a human-autonomous mobile robot order picking system, according to claim 1, wherein multiple items from a same order can be split among autonomous mobile robot and associated human picker teams with the at least one processor.

10. The computerized warehouse management system for managing a warehouse with a human-autonomous mobile robot order picking system, according to claim 1, wherein order batching, assignment, sequencing, and routing is performed utilizing the at least one processor utilizing restarted simulated annealing with adaptive neighborhood search mechanism.

11. A method for managing a computerized warehouse with a human-autonomous mobile robot order picking system, the computerized warehouse management system comprising:
determining operations including how many items should be collected in each tour of at least one autonomous mobile robot, assigning batches to at least one autonomous mobile robot, and developing coordinated routing of the at least one autonomous mobile robot and an associated human picker with at least one processor and memory in communication with the at least one processor having a computerized warehouse management system;
(a) directing at least one autonomous mobile robot of a plurality of autonomous mobile robots to a location of a first item in a batch of items from an initial location with the at least one processor;
(b) determining if a human picker has arrived at that location with the at least one processor;
(c) receiving an item from the human picker by the at least one autonomous mobile robot with the at least one processor;
(d) directing the at least one autonomous mobile robot to move to the location of the next item in the batch and repeat steps (b)-(c) with the at least one processor;
(e) determining if all programmed tours of the at least one autonomous mobile robot have been completed and if not, then repeat steps (a)-(d) with the at least one processor; and
(f) directing at least one autonomous mobile robot of a plurality of autonomous mobile robots to return to the initial location upon completion of step (e) with the at least one processor.

12. The method for managing a computerized warehouse with a human-autonomous mobile robot order picking system according to claim 11, wherein further comprises optimizing a number of items for pickup by the at least one autonomous mobile robot for a tour for each batch with the at least one processor.

13. The method for managing a computerized warehouse with a human-autonomous mobile robot order-picking system according to claim 11, further comprises optimizing each batch assignment for each autonomous mobile robot with the at least one processor.

14. The method for managing a computerized warehouse with a human-autonomous mobile robot order picking system according to claim 11, further comprises the routing of the at least one autonomous mobile robot and the associated human picker to minimize picking time with the at least one processor.

15. The method for managing a computerized warehouse with a human-autonomous mobile robot order-picking system according to claim 11, further comprises determining a speed of the at least one autonomous mobile robot by the processor to optimize efficiency with the at least one processor.

16. The method for managing a computerized warehouse with a human-autonomous mobile robot order picking system according to claim 11, further comprises determining an item holding capacity of the at least one autonomous mobile robot by the processor to optimize efficiency with the at least one processor.

17. The method for managing a computerized warehouse with a human-autonomous mobile robot order picking system according to claim 11, further comprises evaluating wherein a combination of the at least one autonomous mobile robot and associated human picker is evaluated the processor to optimize efficiency with the at least one processor.

18. The method for managing a computerized warehouse with a human-autonomous mobile robot order picking system according to claim 11, evaluating a combination of the at least one autonomous mobile robot and associated human picker with a warehouse layout with the processor to optimize efficiency with the at least one processor.

19. The method for managing a computerized warehouse with a human-autonomous mobile robot order-picking system according to claim 11, further comprises splitting multiple items from a same order among autonomous mobile robot and associated human picker teams with the at least one processor.

20. The method for managing a computerized warehouse with a human-autonomous mobile robot order picking system according to claim 11, further comprises performing order batching, assignment, sequencing, and routing with the at least one processor utilizing restarted simulated annealing with adaptive neighborhood search mechanism.
